(19) United States
(12) Patent Application Publication
(10) Pub. No.: US 2020/0348661 A1
(43) Pub. Date: Nov. 5, 2020

(54) SYSTEM FOR THE CONTROL AND/OR DIAGNOSIS OF AN ELECTRIC DRIVE SYSTEM

(71) Applicant: Lenze Automation GmbH, Aerzen (DE)

(72) Inventors: Christof Ranze, Lilienthal (DE); Edgar Schueber, Ettlingen (DE); Marc Roehrig, Bad Muender (DE); Oliver Hollmann, Stuhr (DE)

(73) Assignee: Lenze Automation GmbH, Aerzen (DE)

(21) Appl. No.: 16/754,603

(22) PCT Filed: Sep. 12, 2018
(86) PCT No.: PCT/EP2018/074576

§ 371 Date: Jul. 7, 2020

(30) Foreign Application Priority Data
Oct. 9, 2017 (DE) 102017123443.8

(51) Int. Cl. G05B 23/02; G06F 3/16; G10L 15/22; G10L 15/30; G10L 15/18

(52) U.S. Cl. CPC G05B 23/0294; G06F 3/167; G10L 2015/223; G10L 15/30; G10L 15/1815; G10L 15/22

(57) ABSTRACT

A system for the control and/or fault diagnosis of an electric drive system, where the drive system may be integrated into the system via a data connection, and may have a user interface for entering a command by a user. The system may be designed to compare a user-entered command with predefined commands and to select a command matching the command entered from the predefined commands. According to an embodiment of the system described herein, in the case of lack of agreement of the command entered by the user with a predefined command, the system may perform an interpretation of the entered command using methods of artificial intelligence in order to assign it to a predefined command.

### TECHNICAL FIELD

The system described herein relates to a system for controlling and/or diagnosing an electric drive system.

### BACKGROUND OF THE INVENTION

The user interface plays an essential role in the control and/or diagnosis of a drive system. In the simplest cases, the control and/or diagnosis of such a drive system is carried out by direct human intervention; i.e., operating parameters such as the power are directly specified and adjusted by means of on-site control elements or read by measuring instruments. This may lead to satisfactory results in the simplest of cases in practice, but it is not enough if the drive systems are part of complex technical equipment, as is often the case in industry.

Possibilities were therefore developed at an early stage to use the means of digital technology to network individual elements of complex drive systems in such a way that control and/or diagnostic tasks can be carried out from user interfaces. The user interfaces receive appropriate input from the users, communicate with elements of the drive system digitally and forward information to the user. This includes, for example, so-called fieldbus systems. For example, a temperature of a drive can be queried at a user interface by entering a corresponding command. The user enters a command that corresponds to a predefined command for the desired temperature query. The user interface then communicates with a measuring unit to which the corresponding temperature sensor is connected. The temperature value is transmitted to the user interface in digitized form and is output to the user. For example, the output to the user may consist of a visual display.

However, with the increasing complexity of a drive system, the number of predefined commands increases accordingly. The operation of the user interface thus places an ever-increasing requirement on the user's previous training. A high level of discipline in its use is also required. The commands must be entered exactly. This is especially important for complex commands that consist of a plurality of predefined command elements.

For example, the query regarding a temperature can be a composite and therefore complex command. The command then contains a first command element, which represents the user's task to the system to read a measurement value. Further command elements can then represent the information of the user to the system that the value to be read out is a temperature value and which temperature sensor it is the temperature value of. Such a complex command already consists of 3 command elements. Any other elements can be supplemented with regard to different functionalities. For example, other command elements can define the type of output, such as displaying on a display or outputting from a printer.

As the number of such possibilities increases, the complexity of operating the system increases. However, particularly in the case of diagnostic tasks, these may have to be carried out under high time pressure and, in addition, often do not constitute routine activities. Scenarios often arise in which the user knows what information he needs and is able to vaguely remember the command required for this, but does not know the exact command.

In these cases, the user must first investigate the exact command for the desired action, for example, look it up in a manual. In the case of complex systems, it also may be necessary to first consider how to form the desired complex command by combining individual command elements so that it can be processed correctly by the system.

Such systems require the user to have a high degree of familiarization with the system itself. Since such systems are often more proprietary in nature, this familiarization must be specific to the respective system.

The cost of requiring such familiarity is correspondingly high if, for example, all technical personnel at a production plant are to be trained in the system. The alternative is to train only a few specialists for the system. However, this has other disadvantages, for example if a corresponding specialist is not available “on site” at all times. However, a function control of such a drive system can cause high downtime costs, for example in the context of production, so that a rapid fault diagnosis is of great importance in an emergency.

### SUMMARY OF THE INVENTION

Described herein is a system for controlling and/or diagnosing a drive system, which has greater user-friendliness than conventional systems.

In some embodiments of the system described herein, the system may control and/or provide fault diagnosis of an electric drive system, where the drive system is integrated into the system via a data connection. The system may have a user interface for entering a command by a user, where the system is designed to compare a command entered by a user with predefined commands and to select a command matching the command entered from the predefined commands. In a case of no agreement of the command entered by the user with a predefined command, the system is designed to interpret the entered command using methods of artificial intelligence in order to assign it to a predefined command.

### DESCRIPTION OF VARIOUS EMBODIMENTS

In some embodiments, the system may be designed to interpret a user-entered command in order to assign it to a predefined command in the event that the command entered fails to match a predefined command. In some embodiments, the system uses methods of artificial intelligence, which makes it possible to enter commands that do not correspond to a predefined command in their syntax, but correspond in their meaning. In this context, this also applies to the selection of individual command elements for complex commands.

In some embodiments, a number of methods known in the field of artificial intelligence are used to enable interpretation of the commands entered, including, for example, so-called “semantic networks” and/or “conceptual dependency theory”.

The system described herein may use a knowledge database in which information about the linguistic use of terms and their possible meanings is stored. The knowledge database may be set up with a view to assigning linguistic terms to unambiguous terms relating to the drive system. That is, words that have similar or related meaning, such as “warm”, “temperature” and “hot,” may be associated with the “operating temperature” technical parameter. Also, conclusions may be drawn from the connection of several words in word groups as to which command or which command element corresponds to the entered command of the user in terms of its meaning.

In cases in which it is unclear which predefined command or which predefined command element is to be assigned to the user's input, the system may be set up to offer the user the predefined commands in question or the complex commands in question composed of predefined command elements as selection options. The user then may make a selection from the suggestions offered and thus quickly get to the desired command.

The system may be designed so that the knowledge database may be adapted and/or extended. The adaptation and/or extension of the knowledge databases may be done by human intervention, for example by adding additional information to the database. In this way, the system may “learn” new terms and their possible associations.

However, it is also possible that the system itself will adapt and/or supplement the knowledge database. For example, assignments may be linked to probabilities for each meaning. If the system can assign multiple predefined commands to a user's input with a sufficiently high probability, the system suggests those predefined commands to the user for selection. Based on the selection made by the user from the suggested commands, the system may correct the probabilities for the respective assignments up and/or down.

In this way, the system may adapt to the language habits of the user. This increases the likelihood that the predefined command that the user actually wants is clearly identified from a user's input and is assigned to the input.

In an embodiment, the system may have acoustic speech recognition. Spoken language may be a convenient way to operate a user interface of such a system. On the one hand, the formulation of user inputs may be carried out comparatively quickly. On the other hand, the user has his hands free, which is a major practical advantage, for example, if the user is formulating a diagnostic query while at the same time carrying out mechanical interventions into the drive system—for example during maintenance and/or repair.

Speech recognition means in particular that the acoustic signal of the user's speech is converted into a corresponding character string, i.e., a text. The character string may be electronically processed for the system and then represent the recognized input of the user.

In some embodiments of the system described herein, the speech recognition is supplemented to give speech comprehension. In such embodiments, the character string generated from the speech is the user input, and is processed as described above. The system described herein thus may offer an advantage compared to known systems, such as a command word controller, that the spoken commands do not have to exactly correspond to the predefined commands.

A conventional command word controller attempts to recognize a predefined command in spoken language, i.e. in the acoustic signal. If, for example, the user uses a synonymous term which differs significantly from the term used in the predefined command, no assignment can be made. In some embodiments of the system described herein, however, the relationship between the synonymous terms which may be stored in the knowledge database of the system is taken into account on the basis of the interpretation of the user input.

The user input recognized in the speech recognition thus may be assigned to the predefined command, i.e., understood, even if the spoken voice command has the same meaning as the predefined command but is completely different from this command in terms of sound. This also applies, for example, to the use of different sentence positions when speaking commands with the same meaning.

In an embodiment, there is a network between a plurality of systems as described herein and/or a higher-level data processing system. The higher-level data processing system may be used to evaluate, compare and/or supplement the knowledge databases of the individual systems.

For example, in some embodiments of the system described herein, if a system uses a term that was not previously known in the system's knowledge database, the system may be supplemented by this term as a new term in its knowledge database. Networking allows the addition to the knowledge database to be transferred to the knowledge databases of other systems.

The higher-level data processing device may have a higher-level knowledge database. In this case, it is also possible for individual systems to send an appropriate request to the higher-level data processing device via a data connection, especially if terms in the user input are not understood. The data comparison of the knowledge databases with the higher-level knowledge database or knowledge databases of other systems according to an embodiment of the system described herein thus may take place controlled by events. It is also possible to perform comparisons of the knowledge databases, for example at fixed time intervals or at specific times which may be specified as part of maintenance plans, for example.

It is also possible to maintain a knowledge database only in the higher-level data processing device. In this way, the decentralized knowledge databases of the individual systems may be eliminated. This has advantages if there are reliable data connections with sufficient bandwidth between the systems and the higher-level data processing device. If this is not the case, it may be advantageous if the individual systems described herein have their own knowledge databases.

Furthermore, it is possible that the higher-level data processing device is designed to collect operating data of the systems connected to the higher-level data processing device. These may be data about operating times, power, speeds, temperatures, service life, voltage curves, currents, angular positions of a motor shaft, operating faults, error messages and/or similar operating parameters, in particular of the electric motors and/or control units of the drive system. This enables the evaluation of these data for a number of drive systems. The knowledge gained in this way may be used, for example, to further develop drive systems, for example to eliminate sources of error that are identified during diagnoses, and to identify user needs that may be used as a basis for sales strategies.

For example, the user interface may be a tablet computer or a smartphone. These regularly have facilities for integration into data networks, microphones, displays and/or loudspeakers, so that they may carry out the function of a user interface according to embodiments of the system described herein. Moreover, they offer the advantage of comparatively free programmability. Tablet computers and/or smartphones also may have their own data storage. This makes it possible, for example, to implement the knowledge database in a smartphone or tablet computer.

The electric drive system may, for example, have an electric motor and/or an inverter and/or a control unit. On the one hand, the electrical energy used to operate the electric motor may be transmitted from the inverter to the electric motor via electrical connections. Furthermore, electrical cables may be used to return electrical signals from the electric motor to the control unit. For example, the electrical signals may be signals from sensors that determine motor operating parameters. The operating parameters may be the speed, the angular position, a temperature, for example generated by the electric motor, operating times, the power consumption, voltages and/or currents, in particular to the rotor and/or stator, information about operating faults and/or error messages.

However, operating parameters of the control unit itself and/or other elements of the drive system also may be recorded and made available to the diagnostic system according to embodiments of the system described herein. Alternatively and/or in addition to the use of the control units for the data transmission-technical integration of the drive system in the system described herein, evaluation units may be used, which may be independent of the control units. These may, for example, detect operating parameters of the drive system by means of suitable measuring devices, and may be integrated into the system according to an embodiment of the system described herein via a suitable data transmission path. Such evaluation units offer advantages in particular if existing drive systems are to be integrated into systems according to embodiments of the system described herein. In such “retrofitting cases”, the compatibility of the existing drive system to the system described herein then may be established via the evaluation units, and the drive system may be integrated into the system described herein.

In an embodiment, the control unit has an interface to a data connection. The control unit thus may be integrated into the system described herein via these data connections. The operating parameters may be queried by the control unit via the data connection.

The drive system may be designed in such a way that a control unit is assigned to each drive. The respective control unit may be integrated into the system described herein via the data connection. A control unit may be assigned to a plurality of electric motors. A plurality of control units in a drive system may be networked with each other. This has the advantage that a plurality of drives may be controlled in a coordinated manner, which may be required in complex technical facilities.

The control units may be directly networked with each other, for example according to a master-slave principle. However, it is also possible that the individual control units are networked with a higher-level controller. In this case, the higher-level controller may cause the control units to be coordinated with each other.

In such systems, signal paths corresponding to the existing networking are possible with the integration into the system described herein. For example, diagnostic queries may be passed from the system to the control units via a higher-level controller. In this case, it may be sufficient if only the higher-level controller has a data connection, via which the drive system is integrated into the system in some embodiments Alternatively and/or additionally, it is possible to integrate the system described herein directly via the control units of the drive system. This may be made possible, for example, by integrating each control unit into the system described herein via a data connection. However, it is also possible in some embodiments, in particular with networked control units, to integrate individual control units or a single control unit into the system described herein, and to forward data signals to other control units via the control units which have a direct connection to a data connection of the system.

In an embodiment, the system described herein is designed to output messages via the user interface when predefined events occur. The predefined events may include, for example, operational malfunctions. Alternatively and/or additionally, messages may be output via the user interface if the detected operating parameters have critical values. Critical values mean in particular values that allow conclusions to be drawn about the failure or impending failure of components of the drive system. This may include, for example: voltage drops; excessive temperature values; deviations of measured voltages and/or currents from setpoint values, e.g., over-voltages and/or over-currents; irregularities in the running behavior; changes in resistance values, for example, changes in the ohmic resistance and/or the inductive resistance of the motor winding; and/or the failure of measuring signals. The type of message output may be a simple warning signal, for example, an acoustic warning tone. Alternatively and/or additionally, it is also possible that messages containing information about the message-triggering event are output. It is also possible that the system is set up to output a warning message first, in order to then output information about the cause of the message in response to a user action.

In some embodiments, the user interface may be, for example, a mobile computer, in particular a tablet computer, and/or a smartphone, which is connected to the drive system via a data connection. Alternatively and/or additionally, a smartwatch and/or virtual reality glasses may be used as a user interface. The user interface may have a knowledge database containing information about the linguistic use of terms that may be associated with predefined commands and command elements.

The control unit of a drive system may be integrated into the system described herein via a data connection. In such embodiments, if a user wants to check the system status as part of the diagnosis of the system, this may be done, for example, by the user speaking a voice input: “What is the status of the drive system?” into the microphone of the tablet computer.

The speech input may be detected by a speech recognition system of the user interface. The system according to embodiments of the system described herein may interpret the speech input using an artificial intelligence of the system, for example, as described herein, which may be implemented in the form of the programming of the tablet computer in the present example. For example, the term “how” may be used to conclude that the speech input is a query. The term “status” may be interpreted to mean that current operating parameters are to be queried, in which context the words “drive system” may be understood as the number of operating parameters to be queried by the system, such that. In such an embodiment, the system described herein may this parameter in this context such that all operating parameters concerning the current status of the entire drive system are to be output, and then may assign the entered command to the corresponding predefined command for this action.

In some embodiments, in a next step, the system queries the operating parameters via a data connection for the components of the drive system integrated into the system described herein. In a next step, the parameters may be output via the user interface, for example, by displaying them on a display.

An alternative voice input also may be “How is the control unit doing?”. Again, the word “how” may first indicate a query when interpreting the command. From the term “control unit”, the artificial intelligence of the system may conclude that the requested information concerns the control unit. Using the language information in the knowledge database, the word “doing” may be understood to be an indication of the functionality of the control device. The command entered therefore may be associated with a predefined command that results in the output of a summary of possible detected problems in the operation of the control unit. For example, the output could read “there are no problems with the operation of the control unit”.

If a fault occurs, for example when a fuse fails, a warning signal could also be output. This initially may consist of a simple acoustic warning signal. For example, a user might respond with the request “which problem is it?” The system may interpret this command as a query as to the type of problem that caused the message and assign the request to the appropriate predefined command. In response to the request, the user may receive the result “there is a voltage drop at the control unit”, for example.

It may be particularly advantageous in some embodiments if the system described herein is set up to output recommendations for action to the user on the occurrence of certain events. For example, the recommendations for action may be the output of the advice “Please check the fuse”.

Other embodiments of the invention will be apparent to those skilled in the art from a consideration of the specification and/or an attempt to put into practice the invention disclosed herein. It is intended that the specification and examples be considered as exemplary only, with the true scope and spirit of the invention being indicated by the following claims.

1. A system for control and/or fault diagnosis of an electric drive system, wherein the drive system is integrated into the system via a data connection,
wherein the system has a user interface for entering a command by a user,
wherein the system is designed to compare a command entered by a user with predefined commands and to select a command from the predefined commands that matches the command entered, and
wherein, in the case of no agreement of the command entered by the user with a predefined command, the system is designed to interpret the entered command using methods of artificial intelligence in order to assign it to a predefined command.

2. A system according to claim 1, wherein the system is designed to process the entered commands and/or predefined commands as complex commands composed of a plurality of predefined command elements.

3. The system according to claim 1, further comprising:
a knowledge database in which information about linguistic use of terms and their possible meanings with regard to the drive system are stored, and wherein the information stored in the knowledge database is adaptable and/or expandable.

4. A system according to claim 1, further comprising:
a speech recognition device for the recognition of the entered command in spoken language.

5. A system according to claim 1, wherein the system is networked with other systems for the control and/or fault diagnosis of an electric drive system and/or a higher-level data processing device via a data connection.

6. A system according to claim 1, wherein the user interface is a computer, in particular a tablet computer, or a smartphone.

7. A system according to claim 1, wherein the drive system has a plurality of electric motors, wherein each electric motor is assigned a control unit, wherein the control units are connected to each other and/or to a higher-level controller.

8. A system according to claim 1, wherein the control units and/or the higher-level controller are integrated into the system via a data connection.

9. A system according to claim 1, wherein the system has at least one evaluation unit for the acquisition of operating parameters of the drive system, which is integrated into the system via a data connection.

10. A system according to claim 1, wherein the system is designed to output messages via the user interface when predefined events occur, including in the event of operational disruptions or when detecting critical operating parameters.

11. A method of controlling an electric drive system, comprising:
receiving a command from a user through a user interface;
comparing the command entered by a user with predefined commands;
if there is a predefined command from the predefined command that matches the entered command, selecting the matching predefined command; and
if there not a predefined command from the predefined command that matches the entered command, interpreting the entered command using methods of artificial intelligence, and assign the entered command to a predefined command based on the interpretations.

12. The method according to claim 11, further comprising:
processing the entered commands and/or predefined commands as complex commands composed of a plurality of predefined command elements.

13. The method according to claim 11, further comprising:
accessing a knowledge database in which information about linguistic use of terms and their possible meanings with regard to the drive system are stored, wherein the information stored in the knowledge database is adaptable and/or expandable.

14. The method according to claim 11, further comprising:
using a speech recognition device to recognize the entered command in spoken language form.

15. The method according to claim 11, further comprising:
acquiring operating parameters of the drive system via a data connection to the drive system.

16. The method according to claim 11, further comprising:
outputting messages via the user interface when predefined events occur, including in the event of operational disruptions or when detecting critical operating parameters.
